(19) United States
(12) Patent Application Publication
(10) Pub. No.: US 2009/0019853 A1
(43) Pub. Date: Jan. 22, 2009

(54) Method and Arrangement for Energy Conversion in Stages

(76) Inventor: Bengt Nilsson, Skoghall (SE)

Correspondence Address: NIXON & VANDERHYE, PC, 901 NORTH GLEBE ROAD, 11TH FLOOR, ARLINGTON, VA, 22203, US

(21) Appl. No.: 12/162,000

(22) PCT Filed: Jan. 23, 2007
(86) PCT No.: PCT/SE07/00056

§ 371 Date: Aug. 19, 2008

(30) Foreign Application Priority Data
Jan. 24, 2006 (SE) 0600154-9

(51) Int. Cl. F01K 23/06; F02C 3/30

(52) U.S. Cl. 60/715; 60/716; 60/775; 60/39.17

(57) ABSTRACT

A flexible method and arrangement provides an effective conversion of energy from any kind of energy sources and/or fuels by combustion and/or gasification, during long-term sustainable economy and environment, by energy conversion in stages. With an open partially circulated condensate system and/or a closed circulation feed water system, stages include first stage of conversion by gasification/combustion, pressurized and/or atmospheric with or without steam- and/or gas-turbines and/or pressurized fuel cell, followed by a second stage of conversion, which second stage utilizing condensation cooling including direct and/or indirect heat transmissions by the first stage produced pressurized mass flow of primary/secondary/residual heat comprising sensible and latent heat, by means of arrangement of expander turbines including counter current fed feed water/condensate fractions during preheating of condensate and feed water respectively before the return to the first stage of conversion. The expander turbines of the second stage with or without co-operation by a third stage of integrated heat transmissions together with the first and second stages effectively transform the mass flow of primary/secondary/residual heat/gas into bio-fuels, mechanical energy as electric power via turbine connected generators, or driving mobile machines/vehicular—a hybrid type of rotation motor during continuous combustion.

### STATE OF THE ART AND PROBLEMS

An embarrassing large part during almost all energy conversions forming a secondary/residual heat, which pressure and/or temperature is insufficient to be interesting for the production of mechanical energy as electric power or other forms of useful work. The secondary/residual heat content of physical energy comprising beside the actual volume flow, pressure and temperature a large part of vaporization/condensation heat—i.e. the sensible and latent heat content respectively—which energy part thus is most desirable to utilize in a more flexible way and especially as mechanical energy, besides the electric power as an example vehicular motor drive as well as all means of transport. All kind of combustion are comprising environmental consequences by the discharge of ground near ozone O₃, nitrogen oxides NOx, greenhouse promotion gases as carbon dioxide and unburned hydrogen carbons as well as a number of unhealthy particles among others as unburned carbon/char and hydrogen carbon particles, heavy metal particles and also aerosols. Furthermore bacteria of legionella constituting increasing problems into the cooling and process water systems.

The extraordinarily high enthalpy of water vaporization makes the vaporization to a very energy demanding process. The water vaporization during the energy conversion by that constitutes an extensive psychical energy uptake, when large amount of energy is consumed. Equivalent amount of vaporization energy is then accessible into the steam/exhaust gas as condensation energy. Secondary/residual heat representing the ending “energy tail” during most of the energy conversions—or more in common expressed; when the process embraces steam and/or gas turbine.

When using condensing power plants, optimized for generation of electric power, the steam turbine discharge of secondary/residual heat is condensed out and fed to sewer, and this considerable part of energy is lost. Also the steam cycle of nuclear power plants with corresponding condensation of the secondary/residual heat—about ⅔ of the total energy amount—is wasted into the recipient/see/air. During summer time it can be restrictions about the permissions of heat discharge into the recipients. At the combined power and heating plants with co-production of electric power as well as a huge part of heat, the total energy content of the fuel is utilized more effectively compared to the possibilities of condensing power plants. However, combined power and heating plants are dependent on neighbouring centres of population to be saleable and find buyers of the too large produced part of secondary/residual heat. That part of energy is marketing by the energy companies as district heat and distributed into nets of considerable proportions. During the summer half year, when huge restrictions of district heat consumption, it will be marketing problems of that energy part resulting in forced restrictions at the synchronous electric power generation.—thus at an inferior economy—which has to be compensated.

Regarding carbon dioxide neutral bio-fuels into a future cycling adapted society based on renewable energy sources, the many different types of liquors within the cellulose industries have an unique position—for an example the black liquor of the sulphate industry—and now it is a necessity for the energy and chemical recovery of the pulp and paper industry to be considered from an overall perspective.

There is also a necessity for a quit new motor technology when driving all kind of means of transport. The conditions of climate, energy and economy are jointly forming a complex of problems. Thus, there is now a great necessity for a much more up-to-date and flexible method for an ultimate energy conversion within the whole global energy sector!

### DESCRIPTION OF THE INVENTION

### Generally

The present invention offers a flexible method and arrangement for the conversion of energy from any kind of energy sources or fuels, by fuel synonymous substances and/or compounds, by energy conversion in stages when the first (I) stage of the conversion, by a closed circulating pressurized steam/feed water system during almost atmospheric or pressurized fuel combustion and/or combustion by an open partially circulated condensate system during pressurized thermal decomposition, stoichiometric and/or sub-stoichiometric—the later pressurized gasification—oxidation/combustion of at least one fuel into at least one process step comprising at least one pressurized reaction/combustion chamber, when said oxidation/combustion/gasification into the open system occurring during increased steam partial pressure by the fuel content of hydrogen and/or water and/or water supply into the fuel and/or into the connection to the said thermal decomposition, said water supply preferably by hot recovered/circulated condensate, when both the systems first (I) conversion stage is followed by a prolonged conversion via the second (II) stage, which second (II) stage constituting condensation cooling in steps through at least one expander turbine or similar apparatus of type rotating machine comprising at least two partial steps with preferably intermediate separation of feed water/condensate, by the first (I) conversion stage produced/utilized energy comprising by the vaporization of the feed water/condensate generated pressurized mass flow containing sensible and latent heat, whereupon condensation cooling occurs during mainly counter current fed media of lower temperature against media before of higher temperature, comprising feed water/condensate fractions for direct or indirect heat transmission or another medium for indirect heat transmission comprising fuel, oxidizing agent and/or cooling medium cycle, during preheating/vaporization of the cooling medium—when needed during superheating—while hot condensate constitutes said water supply into the reaction/combustion chamber within the open system, while the feed water is circulated within the closed system steam cycle, and while the condensation cooling preferably is ended during vacuum and at the open system with separation of clean and cold condensate excess, while said cooling medium cycle constitutes the third (III) conversion stage at the same time as the first (I) and second (II) conversion stages, with or without co-operation through the third (III) conversion stage, producing mechanical energy as electric power via turbine connected generators or to be utilized for a stationary machine/apparatus or any kind of vehicular/means of transport at land, see or into the air.

An open partial circulating condensate system has earlier been described through the Swedish patent C2 526 905.

The method of the energy conversion in stages within both the closed as well as the open system comprising an extensive both system and stage integration, which makes possible an effective conversion of heat/chemical energy to mechanical energy during most of the entire temperature drop.

The pressurized combustion/gasification of the open system—some kind of a turbo system—during increased steam partial pressure preferably takes place within the pressure interval of 2-220 bar (a) and the temperature interval of 300-3100° C. with generated mass flow preferably within the temperature interval 100-1400° C. and the fractionated condensate recovery mainly within the temperature interval 10-370° C. The higher condensate temperature area involves the corresponding very high liquid heat of the condensate, which is recovered by the return into the combustion/vaporization chamber. The lower temperature area—preferably created during vacuum—means cooled both the flue gas as well as the condensate excess.

The extraordinarily high enthalpy of water vaporization makes the vaporization into the reaction/combustion chamber to a very energy demanding process—a huge physical energy uptake—with the corresponding contribution of physical energy to the gas phase/mass flow. This vaporization work is later on recovered as mechanical energy via the condensation energy by the expander turbines and the counter currant step-by-step fed condensate fractions. The water/condensate constitutes by that an intimate natural and effective energy carrier between the sequences vaporization/energy up take and the condensation/energy delivery. The effect of the condensation is secured by the third (III) conversion stage and/or by the heat exchangers of the expansion cooling by utilizing a part of the heat content of the feed water/condensate and/or the steam-gas-/condensate flows to preheat/vaporize suitable media of lower temperature—for example cooled compressed/liquid fuels/oxidizing agents in the form of natural gas hydrate NGH and/or Liquid Natural Gas LNG, hydrogen as well as oxygen etc. The utilization of liquid natural gas LNG as a fuel is achieved by cooling the natural gas down to about minus 160° C., whereby the volume of the fuel is decreased to only about 5-10% of the original volume and by that simplified for transport. However, there is a necessity for a large amount of heat to vaporize LNG at the combustion site, which heat thus is recovered by the condensation cooling. In the same way other liquids/com-pressed media are vaporized as for example liquid hydrogen of temperature minus 253° C.

By the invention all kind of conventional ineffective condensing power plants are eliminated, including the feed water/steam cycle of nuclear power plants which will be much more efficient, as well as the demand of the combined power and heating plants for neighbouring centre of population with corresponding extensive district heating net is eliminated/limited, whereby now there is a possibility to locate plants for energy conversion close to available fuels—as depot or feed pipe for natural gas and hydrogen, domestic waste and forest local bio-fuels, which fuels do not need to be transported far away within extensive collecting areas. Regarding nuclear power plants the necessity of location close to seaside or enormous cooling towers are eliminated. The increasing problem caused by bacteria of legionella into the cooling and process water system is eliminated by the unnecessarily cooling towers.

The first (I) stage of the energy conversion also comprising reaction heat from any kind of process heat and/or another heat, comprising the recovery of calcination energy and geothermal heat, also comprising conventional energy conversion as well as pressurized fuel cell or more in common expressed: where steam and/or gas turbine are involved, which secondary/residual heat to day representing unavoidable and huge “energy tail”.

The first (I) and second (II) stages of the energy conversion, furthermore within the open system, comprising a mostly essential cleaning method of the inert gases originating from the first (I) conversion stage of the pressurized combustion and/or gasification, after which by the second (II) stage condensation out of unburned and unhealthy gas carried particles and aerosols from ultra fine sizes about 0.01μ and larger as well as strongly greenhouse promotion gases of unburned hydrogen carbons, which are returned by the preheated counter current fed condensate for destruction by injection into the fuel and/or in connection to the reaction/combustion/vaporization chamber of the first (I) conversion stage. The increased water steam partial pressure H₂O of the combustion stage is reducing the partial pressure of the hydrogen carbon compounds as CH₄, whereby the ending oxidation of char and the remaining hydrogen carbons are improved—some kind of steam reforming:CH₄+2H₂O [symbol] CO₂+4H₂—at the same time uncontrolled local zones of high temperature are eliminated, which counteracting the generation of for the environment and health care harmful agents and compounds as ground near ozone O₃ and nitrogen oxides NOx.

The present invention thus eliminates/restricts hot water production of the conventional energy conversion and by that also the restricted fixed production relation of hot water vs. electric power, whereby offers by the energy conversion in stages a flexible method and arrangement of producing mechanical energy as electric power by the heat of combustion during almost the entire temperature drop. Thanks to that the production of secondary/residual heat in the state of forced district heat is eliminated/restricted, which heat potential for example in stead is maintained by a system of conventional electrically driven local arrangement of heat pumps during extremely high total energy efficiency, or the power used in another way. The energy conversion in stages thus involves also this arrangement of local heat pumps, constituting the very best economic and environmental friendly way for according to the needs real long distance efficient heat supply, which in this case representing the ending fourth (IV) stage of the energy conversion—an economically and environmentally great technology leap—which in addition also makes possible an integrated energy efficient co-production of both heat as well as cold by cooling plants during a very high total energy factor.

Concerning fuels and by fuel synonymous substances and/or compounds includes part or parts of: hydrogen, hydrogen compounds and hydrogen carbon compounds—including all kind of fossils, but most of all renewable/carbon dioxide neutral bio-mass as forest residuals, peat, rapidly growing aspen, poplar, salix and straw fuels, vegetable and animal oils and grease, digested/bio-sludge, bio-gas etc. and fuel gas from gasification as for example liquors of the cellulose industries, when pre treatment/evaporation of these liquors is best done integrated with the gasification. The application of the invention within the energy and chemical recovery of the cellulose industries stands in a sharp contrary to the standpoint of the technology, representing according to the needs a great technological leap.

Furthermore one valuable energy source within the cellulose industry is represented by the endothermic calcination energy, which corresponding fuel supply is about 40 litres oil per ton of pulp, and this fuel supply is recovered as electric power by the invention.

An exceptional position among fuels/energy carriers constituting steam generating substances and/or compounds, comprising hydrogen H₂ and hydrogen peroxide H₂O₂, which energy conversion are well adopted by the method, among others by the exothermic decomposing reaction of hydrogen peroxide by the large thermo dynamical energy content as well as the stabilising influence on the combustion/gasification process by hydroxide radicals.

Concerning burner nozzles of the reaction chamber all kind of single-/multi-hole nozzles are included—with or without infra/sonic sound generating effect. When use of solid/half solid fuels of type powder, chips and domestic waste etc., the method embracing tightened plug screw feeders PSF.

When oxygen is used as an oxidizing agent followed by the effective condensation of the treated flue gas, the gas contains in principle only carbon dioxide, which simplifies the handling of carbon dioxide as by partial return into the reaction/combustion chamber and/or for sale or long time storing deep into see, or into different geological formations according to the international proclamation “Carbon Dioxide Capture and Storage”—CCS.

The present invention thus involves a binary system by the energy conversion in stages, comprising both the first (I) and second (II) stages of the high temperature loop and when appropriate followed by the third (III) stage of a low temperature loop, whereby opportunities are created for a flexible and up-to-date conversion of heat/mass flow into mechanical energy almost during the entire temperature drop.

When appropriate a chemical recovery in the state of solid phases of dissolved slag/melt and/or as gas phases are integrated. There is a possibility for an extensive heat exchange integration between the high and low temperature loops, whereby the energy conversion is effected during a minimum of energy losses during considerable improved efficiency for the production of for example bio-fuels as well as mechanical energy, which comprising the global entire energy sector during long-term sustainable economy and environment.

The most essential process criteria of the invention comprising, from an expansion point of view, an energy rich gas and/or steam phase 24 which besides the pressure and density consisting of an ultimate volume/mass flow including sensible and latent heat, which within the open system includes optimization of the operation criteria as flow and temperature of the circulating hot contaminated condensate 20, by the liquid heat specific enthalpy h_{f} kJ/kg, which is returned into the reaction chamber etc. for an effective direct acting vaporization.

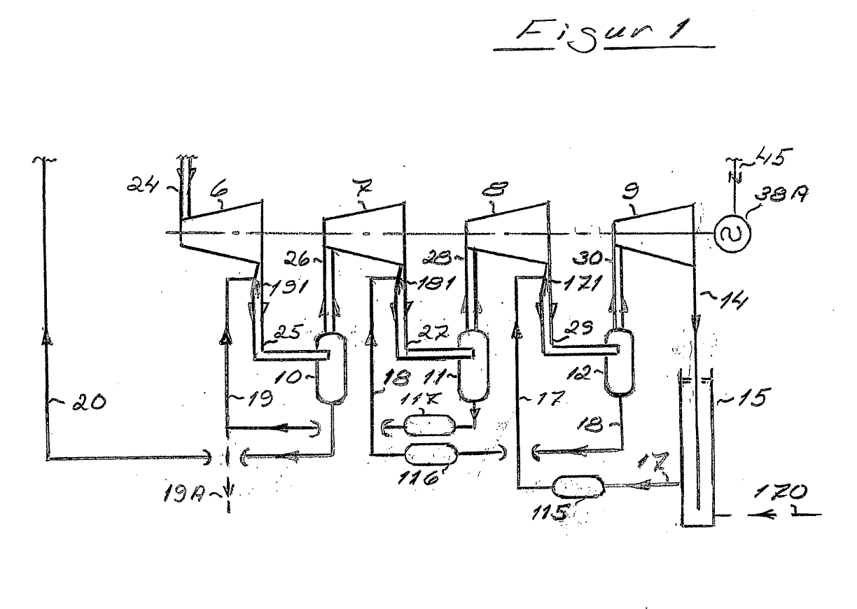

FIG. 1

The figure describes in general the second (II) stage of the counter current expansion cooling during a closed system for feed water handling within some kind of steam/feed water cycle. The arrangement comprises feed water preheating by the counter current fed condensate/feed water fractions, simultaneously the condensation effect of the expansion cooling is more effective above all by the possibility into the counter current fed condensate fractions—as an alternative into the discharge of the expander turbines, which is more evident by later figures—install heat exchangers for in-direct cooling by one or more media. The number of described expander turbines can be both more or less—and as an alternative with individual shafts and generators.

The primary/secondary/residual heat/mass flow 24 connects expansion turbine 6 after which the discharge pipe 25 connects device 10 for a first separation of condensate/feed water 20 from steam flow/residual heat 26, which connects expander turbine 7 after which the discharge pipe 27 connects device 11 for a second separation of condensate/feed water 19 from steam flow/residual heat 28, which connects expander turbine 8 after which the discharge pipe 29 connects device 12 for a third separation of condensate/feed water 18 from steam flow/residual heat 30, which connects expander turbine 9 after which follows an ending separation of condensate/feed water 17 by when appropriate vacuum strengthened barometric fall leg 14 with water seal/tank 15. Supply of feed water 170 occurs for example at the rear part at start up and during operation when needed by feed water of lower temperature, when condensation cooling constitutes an integrated part of an entire whole feed water system, after which corresponding amount of feed water of higher temperature is separated by some of the front fractions for example 18 or 19 as the pipe 19A. Fractions of condensate/feed water are fed counter currant and stepwise by pipe 17 to the discharge 29 via arrangement 171, by pipe 18 to the discharge 27 via arrangement 181, by pipe 19 to the discharge 25 via arrangement 191, after which preheated condensate/feed water 20 returns into actual energy source or utilized in another way, which is cleared by later figures. There is thus a possibility to utilize the heat content of the condensate/feed water for preheating and/or vaporization of suitable media resulting in a more effective condensation cooling, for example by heat exchangers 115, 116 and 117 connected in series or in parallel in condensate piping 17, 18 and 19 comprising the cooling medium of a cooling cycle, oxidizing agent and/or fuel and/or external coolant.

The expander turbine generator 38A generates electric power 45—as follows to be shortened named as power 45.

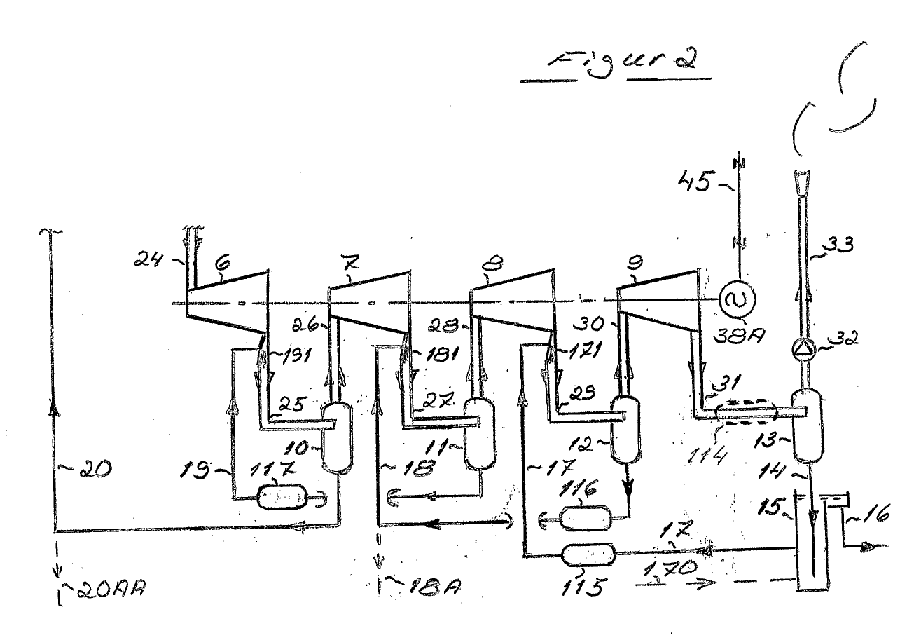

FIG. 2

The figure describes in general the second (II) stage of the expansion cooling during an open system for condensate handling. The arrangement comprises condensate preheating by the counter current fed condensate; simultaneously the condensation effect of the expansion progress is more effective—by the possibility within counter current fed condensate fractions, as an alternative/complement into the discharge of the expander turbines, install heat exchangers for in-direct cooling by one or more media.

The pressurized flue gas/steam mixture constitutes a primary/secondary/residual heat/mass flow 24 and connects expansion turbine 6 after which the discharge 25 connects a device 10 for a first separation of condensate 20 from gas/steam mixture 26, which connects expander turbine 7 after which the discharge 27 connects device 11 for a second separation of condensate 19 from gas/steam mixture 28, which connects expander turbine 8 after which the discharge 29 connects device 12 for a third separation of condensate 18 from gas/steam mixture 30, which connects expander turbine 9 and after which the discharge 31 preferably during vacuum connects device 13 for a last separation of cold, clean condensate excess 16 and treated cold flue gas 33 via fan 32. The discharge pipe 31 can when appropriate have a complementary condenser step—heat exchanger 114 with an external coolant—according to dashed lines. Counter current fed condensate fractions, as well as the ending vacuum generating barometric fall leg 14 with water seal/tank 15, achieve together a prolonged condensation cooling/energy recovery. Addition of external water 170 occurs—for example at start up and when needed during operation, when preheated condensate/water is separated at the front steps for example by pipe 18A. Condensate transports counter current and stepwise according to previous FIG. 1, after which preheated condensate 20 returns into actual energy source or utilized in another way. The generator 38A of the expander turbines is producing power 45.

There is a possibility to separate/recover non process elements NPE/heavy metals 20AA from circulating condensate 20 and/or from other condensate fractions.

There is a possibility to utilize the heat content of the condensate fractions by heat exchangers 115, 116 and 117 according to FIG. 1.

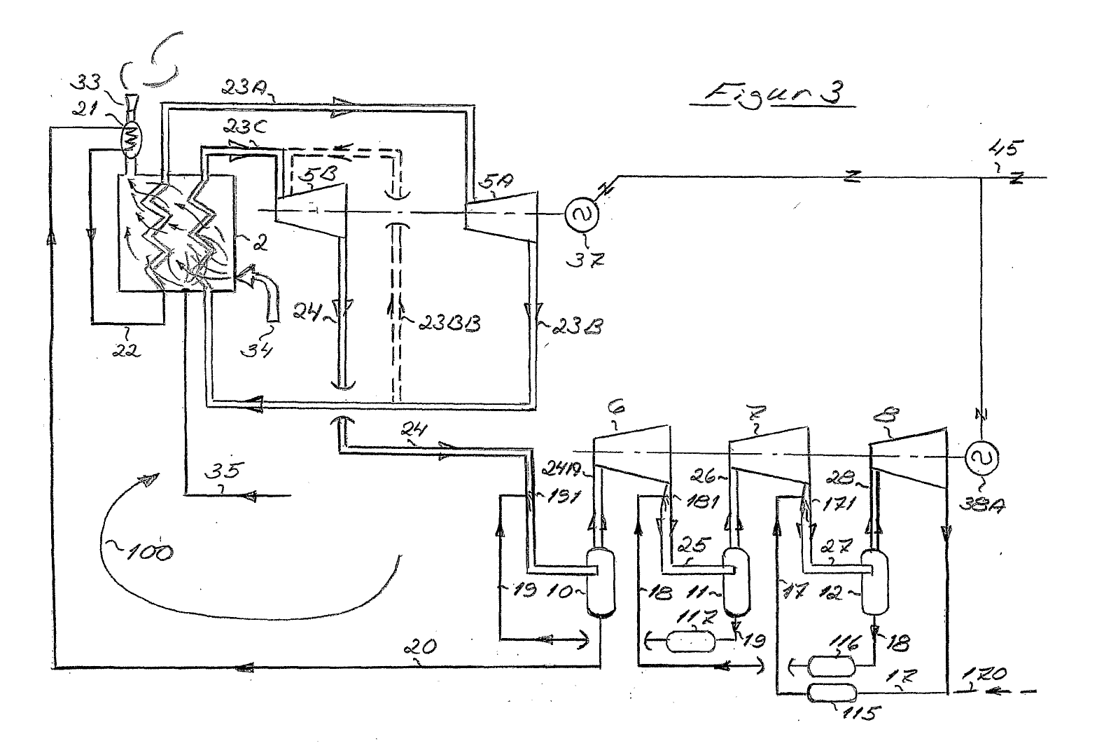

FIG. 3

The figure exemplifies the energy conversion during stages, of a closed condensate/feed water system corresponding to FIG. 1, in the state of a boiler complete with steam/feed water cycle for a conventional combined power and heating plant representing the first (I) stage of the conversion, but thanks to the invention constituting a power plant for power generation. The discharge/counter pressure of secondary/residual heat/mass flow from a conventional energy conversion by high and low pressure steps of steam turbines is condensation cooled by the additional second (II) stage of the conversion by an arrangement of three steps of expander turbines and a counter current return of preheated feed water to the steam boiler. The heat content of respective feed water fractions can earlier have been utilized for the preheating/vaporization of combustion air and/or fuel—when the total energy efficiency and the entire condensation effect are improved.

Fuel 35 and combustion air 34 supplies the boiler 2 for the production of steam 23A into at least one high pressure turbine 5A which discharge 23B, eventually after moist separation and inter stage super heating, is fed by pipe 23C into at least one low pressure turbine 5B preferably with for the steam turbines jointly shaft driven generator 37 for the production of power 45 with a steam discharge 24 from the low pressure turbine 5B, which discharge/counter pressure 24 of secondary/residual heat/mass flow—the energy tail of a conventional energy conversion, is expansion cooled by the invention by three steps in series of expander turbines 6, 7, and 8 with generator 38A for the production of power 45. There is a possibility to feed a part flow 23BB from the discharge of high pressure turbine 5A to the inlet of low pressure turbine 5B according to dashed lines. The pipe 24 connects device 10 for a separation of feed water 20 from the residual heat 24A, which connects expander turbine 6 after which the discharge 25 connects device 11 for the separation of feed water 19 from the residual heat 26, which connects expander turbine 7, after which discharge 27 connects device 12 for further separation of feed water 18 from residual heat 28, which connects expander turbine 8 which discharge of feed water 17 is fed counter current and step wise into the discharge 27 via arrangement 171, by the pipe 18 into the discharge 25 via arrangement 181, by the pipe 19 to the secondary/residual heat/mass flow 24 via arrangement 191, after which preheated feed water 20 returns into boiler 2 when suitable via heat exchanger 21 for still more preheating by hot flue gas 33 and into the boiler renewed production of steam 23A, when the loop is completed. Feed water refill 170 and the installation of heat exchangers 115, 116 and 117 according to previous FIG. 1.

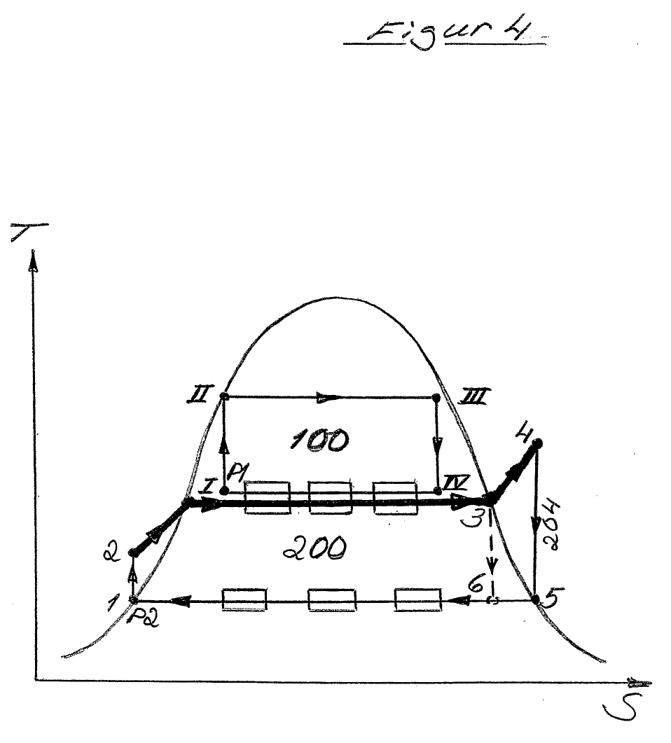

FIG. 4

A high temperature loop 100 and a low temperature/cooling medium loop 200 of a binary system are exemplified by the presented TS-diagram, which cooling medium loop 200 is expressed in the form of an “Ideal Rankine Cycle with Superheat”. The exemplification is only in general form when both the loops are shown within the same medium.

The upper loop 100 starts at pos. I, by pressuring the condensate/feed water by pump P1 up to pos. II, after which the combustion of the fuel takes place during constant pressure and moves the medium/mass flow to pos. III, after which the medium is expanded into at least one gas and/or steam turbine and/or expander turbine to pos. IV with completed condensation by one or more heat exchangers—among others in mutual with cooling medium loop 200—of the secondary/residual heat back to start position I and the pump P1, and the upper loop is completed.

The lower loop 200 starts at pos. 1, by pressuring the cooling medium by pump P2 up to pos. 2, after which preheating/vaporization occurs by above mentioned heat exchangers, in mutual with the loop 100, during constant pressure to pos. 3 with the following super heating by appropriate heat exchanger up to pos. 4, after which follows expansion by at least one turbine 204 or similar apparatus of corresponding function of type rotating machine down to pos. 5 with an ending condensation of the cooling medium by one or more heat exchangers during constant pressure to pump P2 and the start position 1, representing the lower isotherm of the diagram, after which the lower loop is completed. The actual heat exchangers are exemplified as rectangles and when necessary includes external coolant. There is a possibility not to superheat the vaporized cooling medium 200, when the expansion takes place between pos. 3 and pos. 6 according to dashed line, when partial condensation occurs already during the expansion. The stressed line between pos. 2-3-4 is only generalized and represents the vaporization/superheating of the cooling medium and comprises the integrated cooling part of the energy conversion of both the first (I) and second (II) stages during counter current fed condensate fractions by actual heat exchangers within the high temperature loop 100. The cooling medium 200 comprises for the process/temperature area suitable process criteria as volume flow type of cooling medium—for example—ammonia NH₃, HFC, R290 or anything else.

The far driven integration of the binary system stages I, II and III makes the energy conversion possible of produced and/or external heat supply/mass flow into mechanical energy during high total energy efficiency, comprising production of power 45 and/or operation of stationary machine/apparatus or mobile machine/means of transport/vehicular/craft 41.

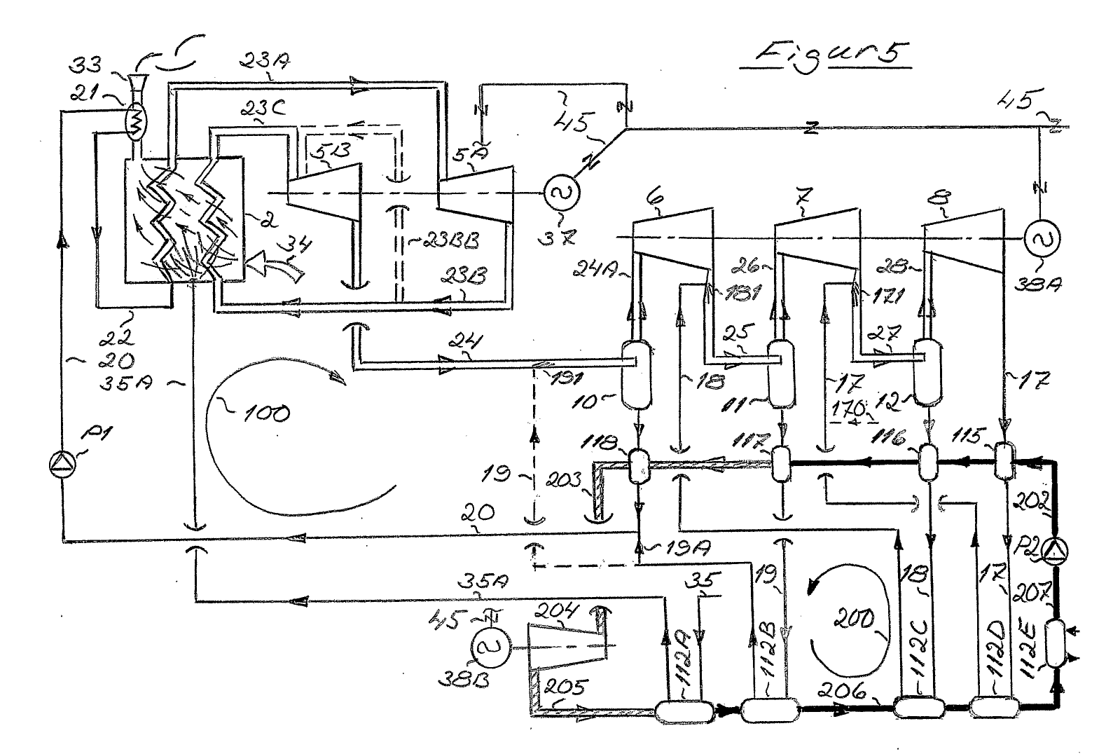

FIG. 5

The figure exemplifies the first (I) and second (II) stages of the energy conversion of a closed condensate/feed water system with the integration of a third (III) stage, which stage consists of a cooling medium cycle 200—the low temperature loop within the binary system. As the conventional boiler energy conversion with adherent steam turbines represents the first (I) stage of the energy conversion, while the residual heat condensation cooling by the expander turbines constitutes the second (II) conversion stage, which both stages make up the high temperature loop 100 earlier has been described, by that the exemplification only covers the cooling medium cycle 200.

The cooling medium cycle comprising for the process/temperature area designed pressure and amount and type of cooling medium—for example ammonia NH₃—when the loop starts by pump P2, after which pressurized liquid cooling medium through pipe 202, by in turns and counter currant, passes the heat exchangers/vaporizers 115, 116, 117 and 118 into respective condensation fractions after which the cooling medium—now preferably in gas phase, eventually superheated—is fed through pipe 203 into at least one expansion turbine 204, or similar device, with generator 38B for the production of power 45, alternatively also turbine driven pump P2, and with the cooling medium now as one-phase or two-phase liquid/gas mixture. The cooling medium is fed by piping 205 into heat exchanger/condenser 112A, which represents pre heater/vaporizer for the fuel 35-35A, in order to lower the cooling medium temperature together with the following condensers 112B, after which condensate fraction 19 is distributed as 19 and/or 19A, and by pipe 206 the cooling medium passing the condensers 112C and 112D for preheating condensate fractions 18 and 17 respectively, after which the cooling medium now again is in liquid form and by pipe 207 fed into pump P2, and the loop is completed. When necessary, one more condenser 112E is installed with an external cooling medium before pump P2.

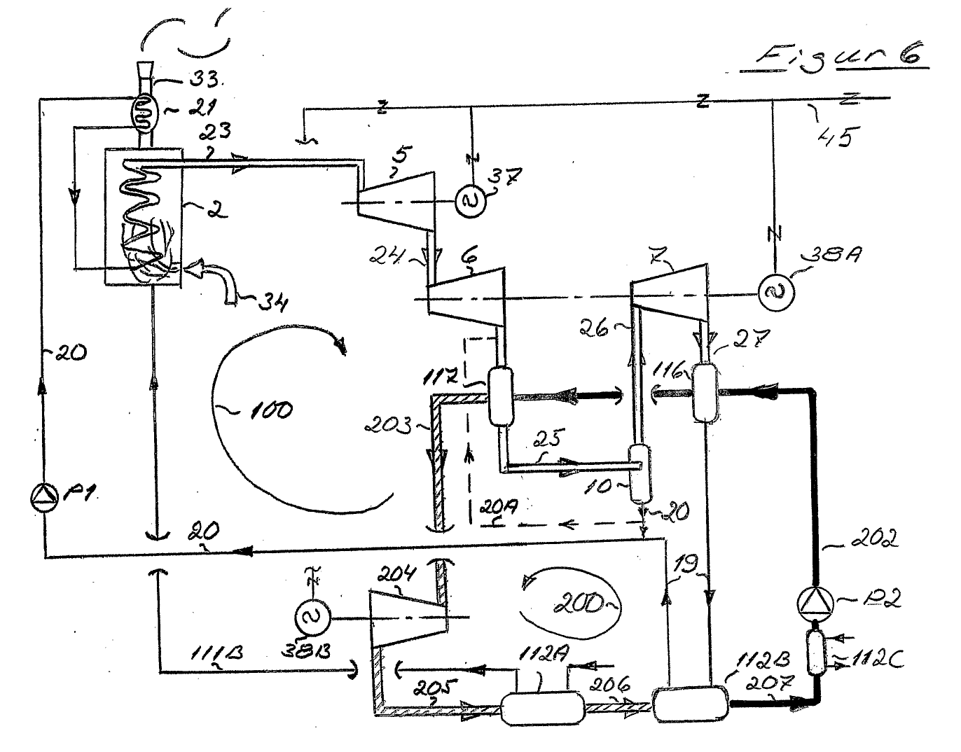

FIG. 6

This figure represents a modification of the earlier description of the closed system by reducing the number of turbine steps to two—pos. 6 and 7—and changed positions of the heat exchangers/vaporizers/super heater 116 and 117 into the discharge pipe of the expanders for an alternative/strengthened condensation cooling. There is a possibility to circulate part of the condensate fraction 20 by the flow 20A (according to dashed line) in order to control the heat transmission at heat exchanger/vaporizer 117. The cooling medium cooled feed water fraction 19 is re-heated by condenser 112B before the return to boiler 2 by the entire condensate 20.

The exemplified expander turbine step 5 can be used as both high and low pressure turbines in accordance with FIG. 3.

When appropriate additional condensing capacity is installed by heat exchanger 112C.

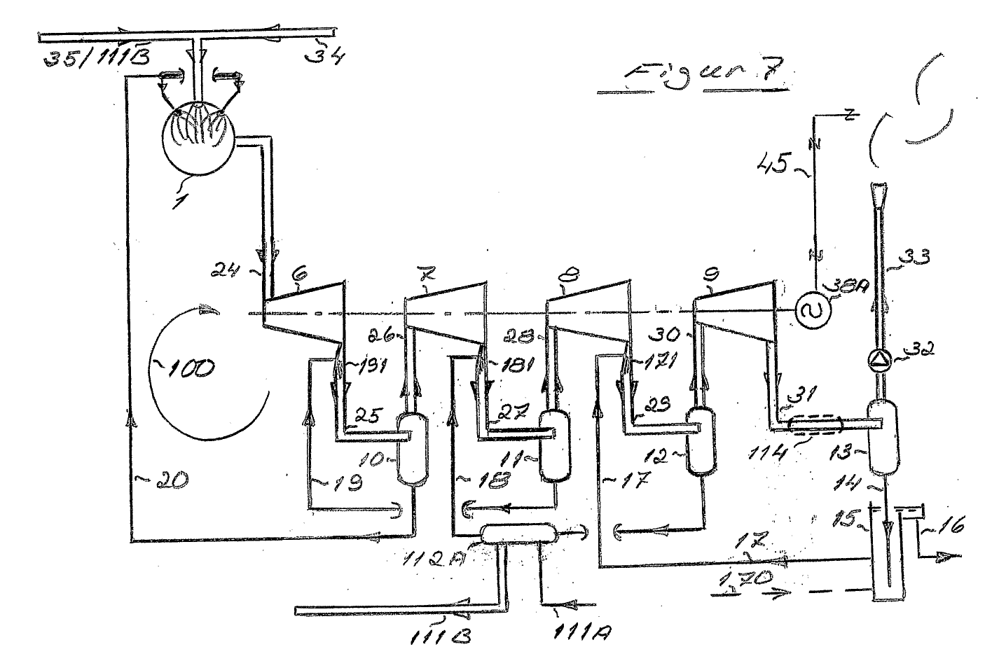

FIG. 7

The arrangement exemplifies the energy conversion in stages, the first (I) and second (II) stages of the high temperature loop 100, by an open system according to the general FIG. 2 as a hole, embracing the first (I) energy conversion reaction chamber 1 for pressurized combustion/vaporization—some kind of a turbo method—by the supply of fuel 35/111B, oxidizing agent 34 and preheated condensate 20 by injection into fuel and/or in connection to the reaction chamber 1. The temperature as well as the steam partial pressure of the exhaust/flue gas 33 is settled by the returned hot condensate fraction 20 of the counter currant condensation cooling as well as the counter/discharge pressure 31 of the expander 9, preferably during vacuum in accordance to earlier descriptions.

When for example use of liquid natural gas as a fuel 35/111B the vaporization heat takes from the condensation heat exchanger 112A according to previous descriptions.

When necessary the condensation effect at pipe 31 before the exhaust can be strengthened by an additional condenser 114 as an external coolant according to dashed marketing.

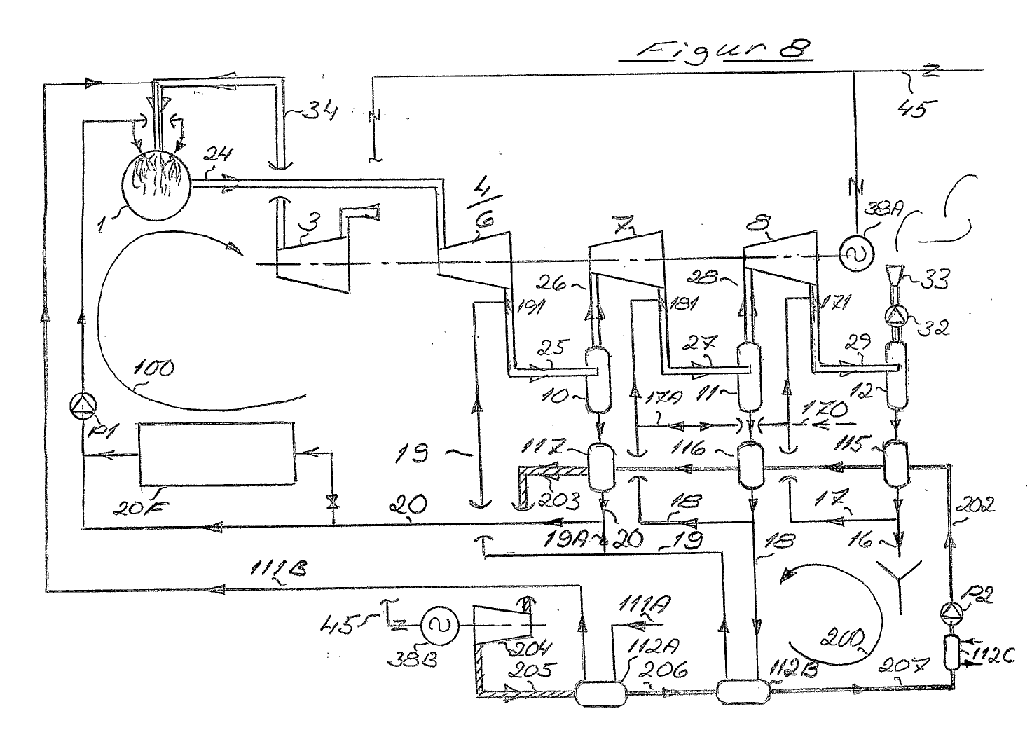

FIG. 8

The above described figure within the open system is modified by reducing the number of expander turbine steps to three—4/6, 7 and 8—and the air compressor 3 is shown as well as a require controlled/restricted municipal heating network 20F and the integration of a cooling medium 200 in accordance with earlier descriptions. As an alternative the expander turbine 6 can be replaced by a gas turbine as shown by pos. 4. When necessary additional condenser capacity is installed by heat exchanger 112C.

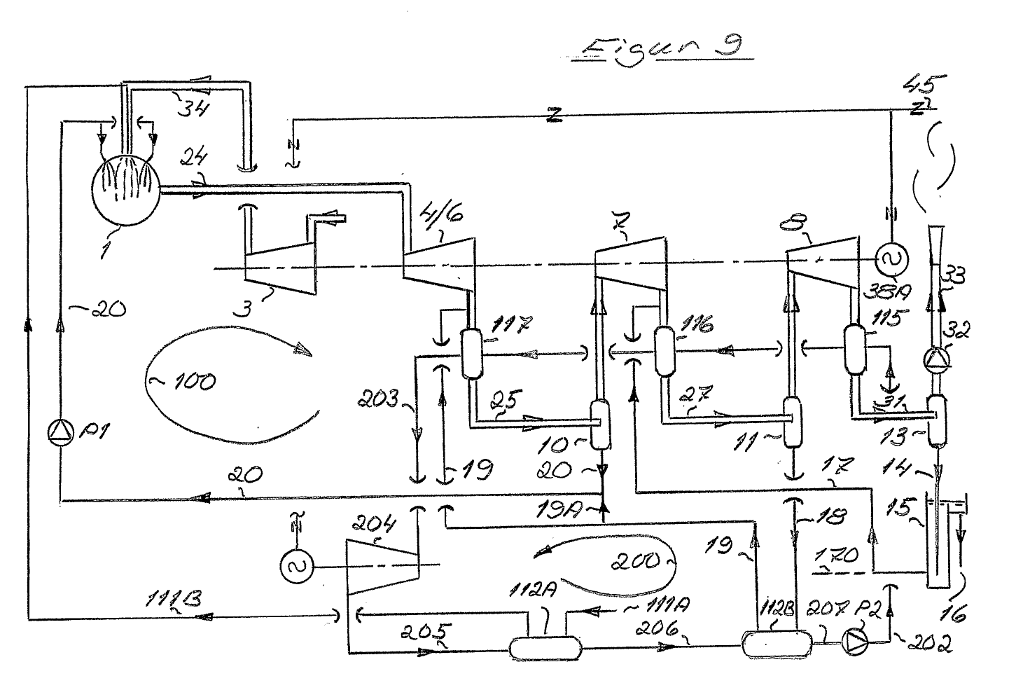

FIG. 9

The figure describes both the first (I) and second (II) stages of the conversion within an open system, with the integration of a cooling medium cycle 200 of the third (III) stage according to previous descriptions, besides the changed position of heat exchangers 115, 116 and 117 of the figure which are installed into the discharge piping of the expander turbines.

There is also a possibility to install the heat exchangers, as for example 117 in the pipe 25, for a condensate recovery in counter current position vs. the gas flow, resulting in an effective heat exchanger wash, which is not cleared by figure. When necessary additional condenser capacity can be installed in pipe 207, which is not cleared by figure.

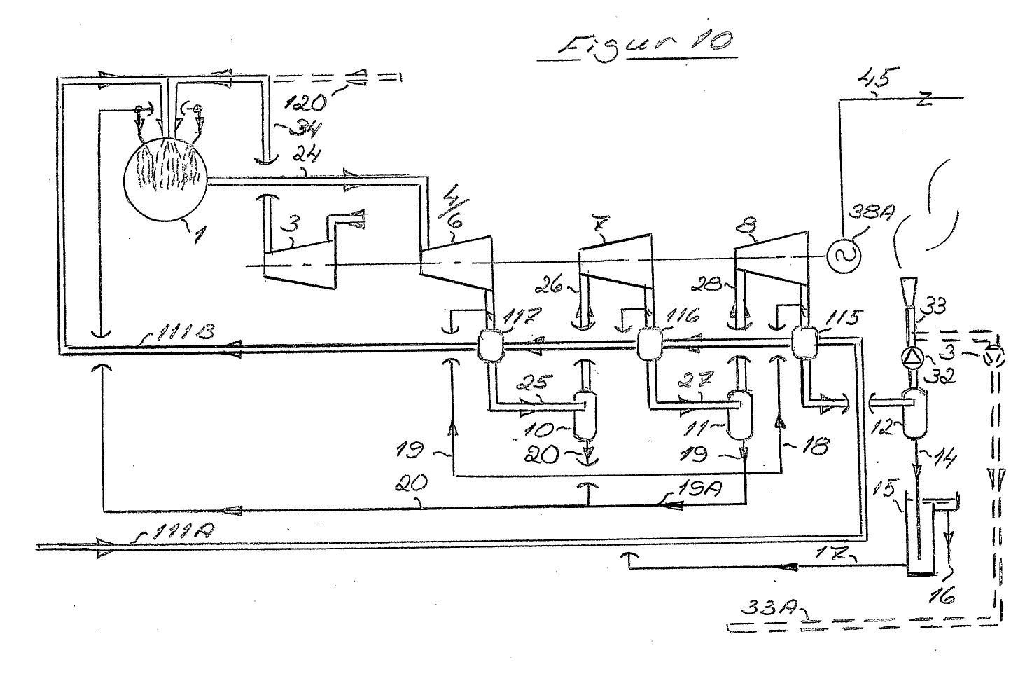

FIG. 10

This figure describes a modified method of the previous figure, by replacing the cooling medium of the low temperature loop 200 by the preheating/vaporization of fuel 111A-111B—preferably as liquid hydrogen and/or liquid natural gas, natural gas hydrate or equal.

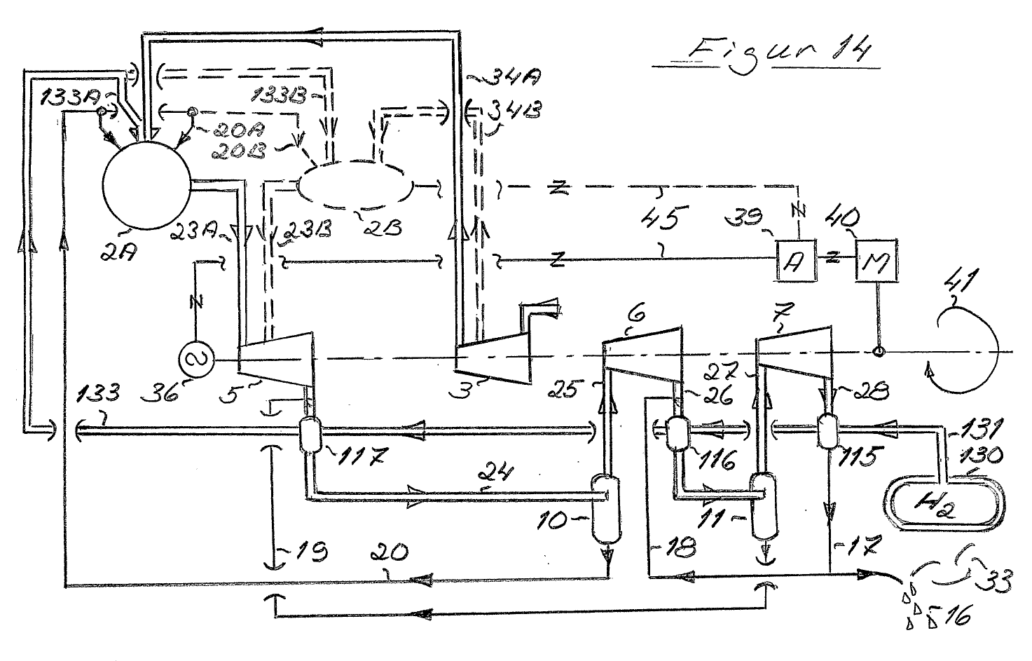

There is a possibility—by some modifications—the figure also representing a quit new rotation motor technology for vehicular drive according to later FIG. 14.

From an environmental point of view interesting possibility when using fuels producing carbon dioxide preferably in combination with oxygen 120 as an oxidizing agent, is to compress the condensation cold/cleaned flue gas of close to only carbon dioxide 33A to be forced down deep into see or appropriate geological formation for long-time storing—in accordance with dashed marking—which by the way is possible at most of the exemplifications within the open system. Also oxygen 120 is to be preheated and vaporized by available condensation heat, which is not cleared by figure, when the compressor 3 in stead is utilized for the compression of carbon dioxide 33A.

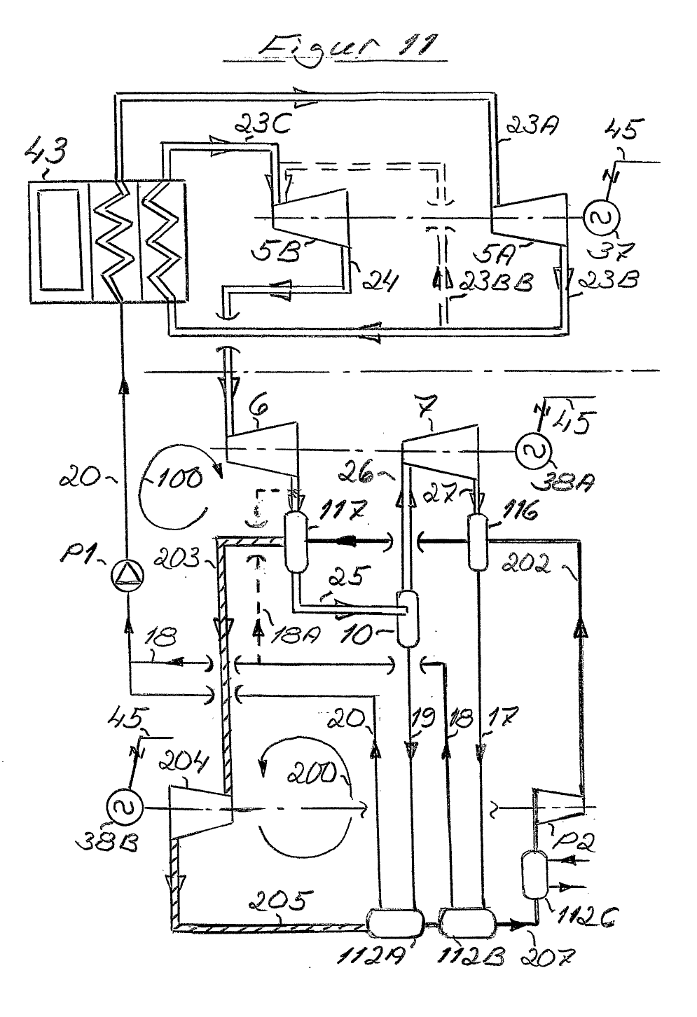

FIG. 11

The figure describes energy conversion within a closed steam/feed water system in accordance with earlier descriptions, but here the steam is produced at any kind of nuclear power plant 43 with subsequent generator equipped steam turbines—representing the high temperature loop 100 of the binary system. By more or less replacing the conventional condensation cooling of the steam turbine residual heat including dumping into recipient, all or most part is instead by the invention—below the horizontal marked line—converted into preheated feed water and power 45. Thanks to the invention the need for coast near installation or enormous cooling towers is eliminated.

Steam 23A within the first (I) stage of energy conversion, at for example 60 bar (a) and 280° C. connects at least one high pressure steam turbine 5A which discharge 23B—eventually after moisture separation and an intermediate stage of super heating—connects at least one low pressure steam turbine 5B by the pipe 23C at for example 10 bar (a), preferably by for the turbines in a jointly shaft driven generator 37 for generation of power 45 with the residual heat discharge 24 from the low pressure steam turbine 5B for example within the area of 0.7-5 bar (a), which residual heat 24 connects the second (II) stage of the energy conversion by expander turbine 6, after which from the expander turbine 6 discharge of residual heat/feed water 25 passes heat exchanger/super heater 117 within at least one cooling medium cycle 200 and after that device 10 for separation of feed water 19 from residual heat 26, which connects next expander turbine 7, during power generation via generator 38A, after which the discharge of residual heat/feed water 27 passes heat exchanger 116 within a cooling medium cycle, for the final condensation of the residual heat 27 preferably during vacuum, after which feed water 17 connects the heat exchanger/condenser 112B of the cooling medium cycle for simultaneous preheating, after which feed water as fraction 18 connects the pipe 20 and/or by pipe 18A (dashed line) the discharge 25 of expander turbine 6 after which the separated feed water 19 by device 10 connects the heat exchanger 112A of the cooling medium cycle for simultaneous preheating the feed water as fraction 20, which representing the nuclear power plant 43 feed water cycle, after which the steam flow 23A is ready for another steam/feed water cycle.

When requiring more condenser capacity this is to be installed in the cooling medium cycle by heat exchanger 112C with an external coolant and/or in another suitable medium to support the condensation.

The cooling medium loop 200 is chosen according to the needs and the loop has been described by previous figures.

Power 45 is thus produced via the first (I) stage generator 37, the second (II) stage generator 38A as well as the third (III) stage generator 38B.

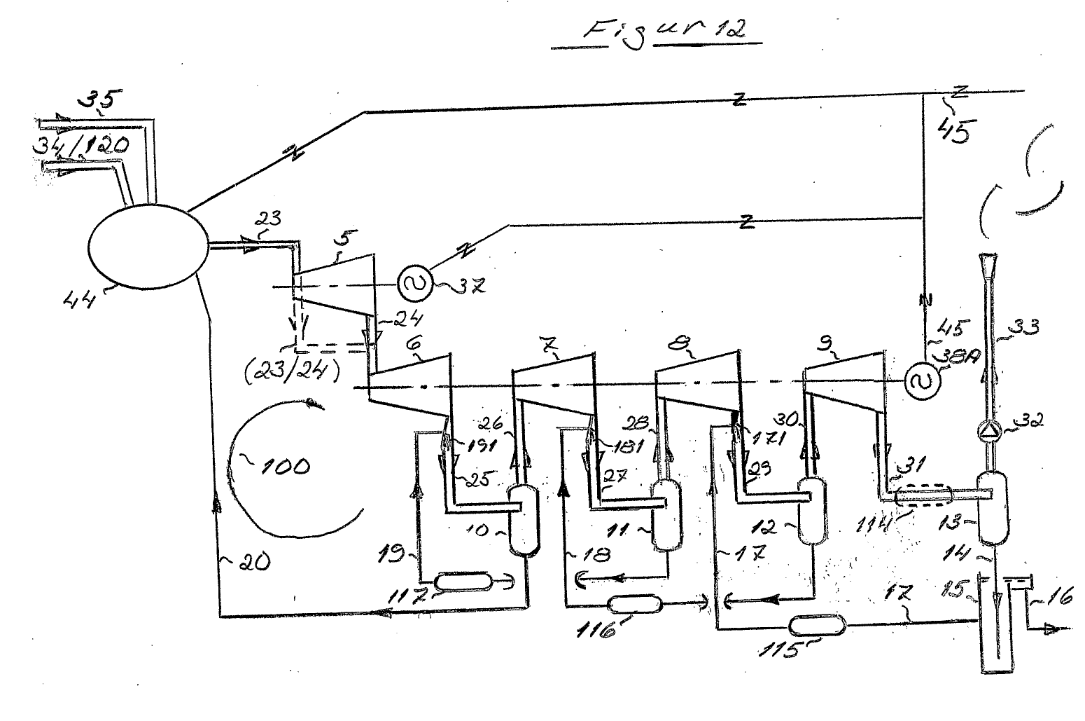

FIG. 12

The figure exemplifies the energy conversion in stages by a pressurized fuel cell representing the first (I) stage of the energy conversion. This fuel cell is producing, in accordance with otherwise known process, both power as well as steam but with the difference by the condensation cooling system the recovered hot condensate returns to the fuel cell to be vaporized and for a temperature control of the produced mass flow. The higher temperature of the pressurized fuel cell—in relation to an atmospheric one—gives a higher efficiency and facilitates the conversion of hydrogen and oxygen to steam and power during less/without costly catalyst—for example platinum. Both the fuel and oxidizing agent represents a number of hydrogen and oxygen containing substances and compounds comprising besides hydrogen, oxygen and hydrogen peroxide, also dimethylether DME, alcohols and conventional hydrogen carbon compounds. Liquid hydrogen, oxygen and natural gas LNG can be vaporized by heat exchanger 115, 116 and 117 according to earlier descriptions.

Pressurized fuel cell 44 is supplied fuel/energy carrier 35, oxidizing agent as compressed air 34 and/or oxygen 120 and circulated preheated condensate 20, when power 45 and steam/gas/mass flow 23 is produced, which connects the expander turbines directly for condensation cooling according to dashed marking 23/24, or connects any kind of at least one step of steam turbine/rotating turbo machine 5 as an intermediate step, after which the discharge 24 or 23/24 connects by FIG. 2 generally described condensation cooling by the four steps of turbine 6, 7, 8 and 9 including counter current fed condensate. The arrangement producing power 45 by both fuel cell 44 as well as via generators 38A and when appropriate 37. When utilizing fuel without carbon content, no carbon dioxide containing flue gas is produced and the fan 32 and chimney 33 are excluded, which is not cleared by figure.

The counter current fed cooling medium cycle 200, in accordance with previous figures, can be utilized also within this arrangement, which is not cleared by figure.

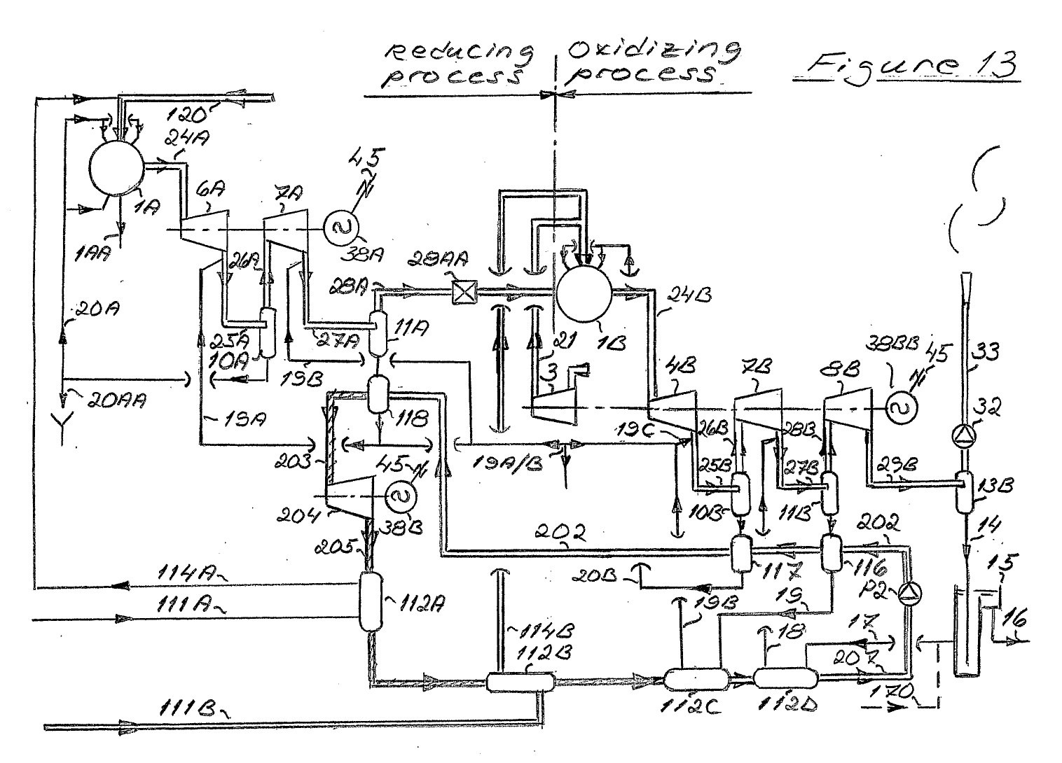

FIG. 13

This figure describes the very great flexibility and the great number of varieties of the present invention in the form of recovering energy and chemicals from liquids within the cellulose industry—for example black liquor. The high temperature loop of the binary system comprising a pressurized reducing process step followed by a pressurized oxidizing step, both steps are integrated by a low temperature cooling medium loop 200, which medium is fed counter current, both internally within respective process step as against both the process steps order, where by the stepwise vaporization of the cooling medium loop starts within the ending process step, after which the vaporization of the medium is completed within the first process step before—preferably during superheating. After that the cooling medium loop passes by in turns at least one expander turbine—or similar device—with generator, preferably without any condensation, and after that four heat exchangers/condensers with the possibility for if necessary additional condenser capacity by some external cooling medium (not cleared by figure), after which the cooling medium is liquefied and the loop is completed.

The reducing process step includes a fuel gas cleaning step during preferably partial moisture condensation, followed by the oxidizing process step of almost complete moisture condensation of the flue gas. The first process step comprises reaction chamber for the gasification/vaporization with the adherent quench as a dissolver of the recovered melt/chemicals—mainly Na—/K-compounds. There is also a possibility for a recovery of chemicals from the reducing fuel gas phase as synthesis gas (H₂ and CO), which can be obtained for the production of for example hydrogen peroxide (H₂O₂) and/or a number of different mobile automotive/bio fuels comprising hydrogen, dimethylether (DME) and methanol (CH₃OH).

The reducing process step of fuel consists of black liquor preferably of lower dry substance content with kept natural amount of sulphate soap—and the oxidizing process step of fuel consists of by the previous step produced fuel gas and as a possibility with an additional fuel supply. This supply for example comprises bio gas or some kind of natural gas—which preheating/vaporization, also includes liquid oxygen, representing a part of mentioned heat exchanger/condenser of the cooling medium loop.

The entire black liquor recovery process can be both simplified and more effective by excluding the conventional separation step of the energy rich sulphate soap within the evaporation plant, resulting in an increased obtainable synthesis gas and/or power corresponding to the high energy content of the into the black liquor left sulphate soap.

The operation criteria of the reducing first process step are preferably high operation pressure as well as high steam partial pressure, and with respect to the carbon conversion lowest possible operation temperature into the gasification reactor, which makes possible an effective split of alkaline and sulphur compounds—the later as hydrogen sulphide (H₂S) as a part of the fuel gas. The recovery of hydrogen sulphide, which only is cleared by the figure in principle, occurs by conversion to elementary sulphur S and/or by selective absorption in alkali preferably by some kind of short time contactor—one or more static and/or dynamic devices preferably in counter currant series—and/or the production of polysulphide and/or the supply of S and/or H₂S into another reaction chamber for gasification of a partial flow of black liquor—and/or another liquor, for example when appropriate sulphate soap—at low operation pressure, approx. 2 bar(a), for in the reaction chamber direct conversion/production of high sulphidity white liquor Na₂S by displaced equilibrium reaction against right according to:

Na₂CO₃+H₂S [symbol] Na₂S+CO₂+H₂O

The recovery of chemicals after the quench/melt dissolver would be best done by keeping a high suitable operation pressure into the entire chemical recovery cycle as causticizing, calcination etc.—which is not cleared by figure.

Black liquor 111A/114A is preheated by the condenser 112A of the cooling medium loop 200 and fed into the reducing, pressurized reaction chamber 1A together with preheated, returned condensate 20A and oxygen 120 followed by quenching/separation/dissolving of the solid/melt phase of recovered chemicals 1AA by a part of condensate 20A or another water containing medium. In order to prevent enrichment of non process elements NPE into the circulating condensate 20A a small flow 20AA can be separated. Pressurized fuel gas/mass flow 24A of high steam partial pressure, almost moisture saturated, leaves the reaction chamber 1A and connects expander turbine 6A, which discharge 25A connects device 10A for separation of condensate 20A from the fuel gas 26A, which connects expansion turbine 7A, and the discharge 27A connects device 11A for the separation of condensate 19A from fuel gas 28A, which condensate is fed counter current into the discharge 25A and contaminated hot condensate 20A injects the reaction chamber 1A. It is an advantage to connect the non condensable gases (NCG) 114BB into piping 28A.

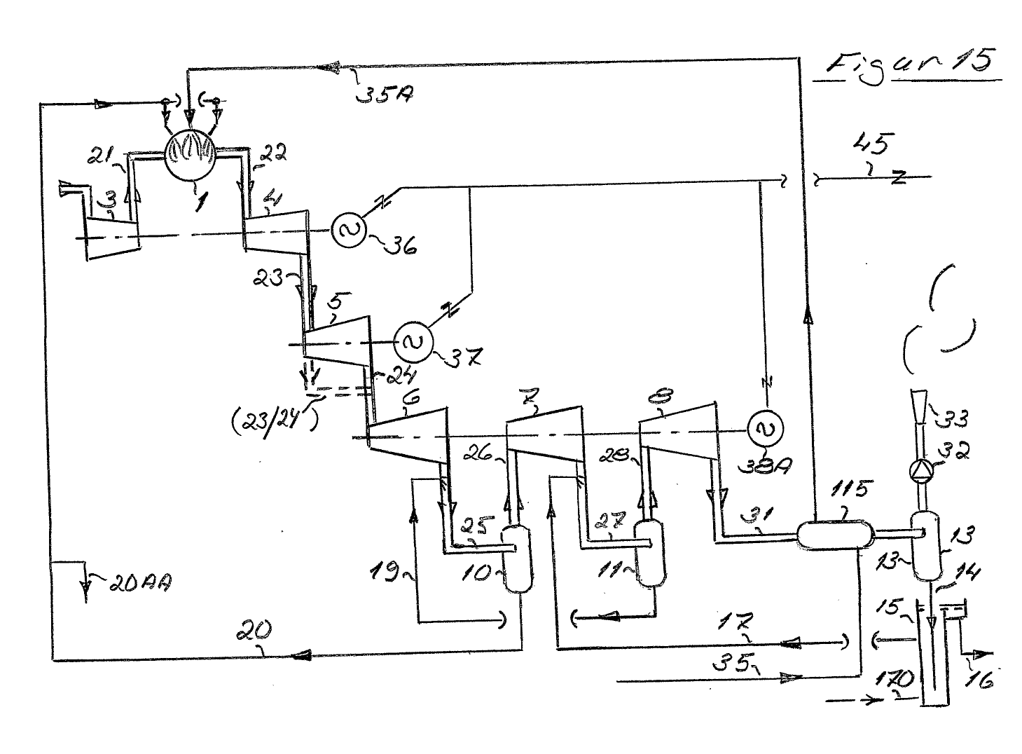

From the fuel gas 28A is thus possible to obtain a number of chemicals via a symbolic shown device 28AA, after which the fuel gas/rest of fuel gas 28A connects the combustion chamber 1B of the oxidizing process step for a stoichiometric combustion by compressor 3 supplied air 21 and returned preheated condensate 20B, preferably with an additional fuel 111B/114B which has been preheated/vaporized by the condenser 112B of the cooling medium loop 200. There is a possibility to distribute the condensate fractions between the reducing and oxidizing steps by 19A/B and/or when at an excess to be separated as for example pulp wash water. Pressurized flue gas 24B at high steam partial pressure leaves the combustion chamber 1B and enters a gas turbine 4B, when the combustion chamber 1B represents a part of the entire gas turbine neither with it's own shaft and power generator in accordance with FIG. 15, or as shown by figure in conjunction with the expander turbines, after which the discharge 25B connects device 10B for separation of condensate 20B from flue gas 26B, which enters expander turbine 7B, and the discharge 27B connects device 11B for separation of condensate 19 from flue gas 28B, which enters expander turbine 8B, and after which the discharge 29B, preferably during vacuum, connects device 13B for separation of cold, clean condensate excess 16 via barometric fall leg 14 with water seal 15 from cold, treated flue gas 33 by fan 32. The condensate fraction 19B is preheated by heat exchanger/condenser 112C and distributed as 19 A/B and/or 19C. The condensate fractions are stepwise fed counter current through the heat exchangers/condensers of the cooling medium loop 200 to be injected into the reactor chamber 1B etc. according to earlier descriptions.

There is thus a possibility to utilize condensate fractions as 19A/B for pulp washing, if necessary for the water balance with the supply of a compensation flow of low temperature water, waste water, cold water etc.

There is a possibility to complete/exclude the cooling medium loop 200 by the preheating/vaporization of liquid natural/bio gas as the additional fuel 111 B/114B and/or oxygen 120, which are fed step wise and counter current the heat exchangers according to earlier figures.

FIG. 14

The figure describes the pressurized fuel conversion in stages of at least one fuel 131 for driving mobile machine/vehicular/means of transport/craft 41—a vehicular of hybrid type driven by a rotation motor of a quit new motor technology during continuous combustion. This pressurized/turbo method comprises compressor 3 for the supply of air 34A/34B, and the number of expander turbines are three when including at least one step of steam turbine 5 followed by two turbo expanders 6 and 7. The method also describes a pressurized fuel cell 2B—corresponding to FIG. 12—by dashed lines, whereby is cleared the figure comprises three different arrangements: the entire via both at least one reaction/combustion chamber 2A and at least one fuel cell 2B and furthermore either via only reaction chamber 2A or via only the fuel cell 2B—besides the alternative of an electrically driven hybrid vehicle.

The figure has the same position markings as previous exemplifications, and by that follows a shortened description.

Liquid hydrogen 131 at approx. minus 250° C. is passing in series and counter current the heat exchangers/vaporizers 115, 116 and 117 and connects reaction/combustion chamber 2A and/or fuel cell 2B via connections 133A and 133B respectively. Counter currant fed fractions of condensate 17, 18 and 19 connects by pipe 20 reaction/combustion chamber 2A and/or fuel cell 2B via piping 20A and 20B respectively. The circulating amount of condensate 20 is controlled by the discharge amount of fraction 16. When use of non carbon content fuels the only discharge consisting of clean cold condensate excess 16 and if not use of oxygen 120 the compressed air 34 content of nitrogen 33. Generator 36, which can be reversed to a start motor as an alternative to a separate one, feeding when necessary accumulator/battery 39 by power 45, as a complement to power 45 from the fuel cell 2B, and by that a possibility for an alternative electrically driven motor 40.

The discharge only consists of water/condensate and when use of compressed air the nitrogen content. The acidification by nitrogen oxides and ground near ozone are both minimized thanks to the temperature controlled combustion/oxidation.

Liquid/compressed fuels as hydrogen, and or natural gas in the form of LNG and/or NGH are extraordinarily advantageous. Liquid hydrogen expands approx. 840 times when vaporized.

The method is also use full—by small modifications—for a stationary power plant corresponding to FIG. 10, which is not cleared by figure.

FIG. 15

As a conclusion of the present invention an open system is exemplified by an integration of a gas turbine arrangement in the energy conversion first (I) stage.

The combustion chamber 1 of the gas turbine is preferably supplied a preheated/vaporized fuel 35/35A, via for example heat exchanger/cooler 115, and compressed air 21 via compressor 3 of the gas turbine and circulated preheated condensate 20, which condensate is injected into the fuel and/or in connection to the combustion chamber 1, after which moistened flue gas 22 connects gas turbine 4 for the generation of power 45 via generator 36. The gas turbine hot discharge of flue gas/steam 23 connects some kind of at least one steam/intermediate turbine step 5, or similar apparatus of corresponding function of type rotating machine, with generator 37 for generation of power 45, and/or direct as a mass flow into the expander turbines via dashed line 23/24, for generation of power 45 via generator 38A, when thus discharge 24 or 23/24 connects the expander turbine stages 6, 7 and 8 of the expansion cooling. When risk for enrichment of impurities/heavy metals etc. into the circulating condensate 20, a small flow 20AA is separated.

This figure is also applicable by some modifications for driving vehicular/means of transport corresponding to FIG. 14, which is not cleared by figure.

Earlier shown heat exchangers 116 and 117 into the discharge of expander turbines or into the condensate fractions are also applicable within this figure as well as the cooling medium loop 200—which alternatives are not cleared by the figure.

### Comments to the Figures

The figures of the present invention are describing the characteristics and great varieties of the energy conversion in stages from an overall perspective based on a quit new system thinking applicable within the entire energy sector. The conversion in stages in the state of an open and/or a closed system during counter currant fed condensate/feed water fractions, including the return of preheated condensate/feed water, makes possible the ultimate energy conversion during an overall optimization with reference to both environment as economy.

The method facilitates carbon dioxide handling, comprising the final deposit deep into see or geological formations and furthermore eliminates the unhealthy discharge of particles/sub-microns as well as unburned hydrogen carbons etc. as well as water steam/aerosols with corresponding reduction in cloud formation. Fuels which only generate steam/condensate are most suitable and especially within the huge transport sector by the continuous combustion with rotation motor drive of the invention.

In general there are no transport pumps and control systems shown in any of the subsequent figures.

### Comments to the Extent

It must be understood that during certain circumstances the oxidation progress occurs without any real flame.
It must be understood that combustion/thermal decomposition complains both partial/under stoichiometric as total/stoichiometric oxidation, which process steps can be used in series.
It must be understood within the open system produced/utilized pressurized mass flow can be as well superheated as moisture saturated or almost moistened.
It has to be understood both the gas and the steam turbine steps can be installed as well before as after the expansion cooling expander turbines.
It has to be understood some arrangement needs additional condenser capacity by external cooling medium.
It has to be understood the invention also includes so called “sulphur free” cellulose processes as well as “causticising free/causticising reduced needs” recovery processes.
The present invention is not restricted to the described performances but can be varied within exemplified figures and combined within the scope of the following patent claims.

1. Method for recovering energy from any kind of energy sources by energy conversion in stages when the first (I) stage conversion, with or without at least one gas and/or steam turbine for generation of electric power (henceforth only named power) and/or production of another kind of mechanical energy, by at least one closed circulating steam/feed water system and/or by at least one open partially circulating condensate system with separation of condensate excess, both the systems during thermal decomposition and/or stoichiometric and/or substoichiometric oxidation/combustion of at least one fuel in at least one reaction/combustion chamber or another arrangement of corresponding functioning, when at a closed feed water system said oxidation/combustion is almost atmospheric or pressurized, when at an open condensate system said oxidation/combustion occurring during pressure and increased steam partial pressure by the fuel content of hydrogen and/or water and/or supplying water separately, followed by the energy conversion of a second (II) stage, which stage representing condensation cooling of by the first (I) stage utilized/produced energy in form of pressurized primary/secondary/residual heat/mass flow, without or with content of inert gases depending upon a closed or an open feed water/condensate system, by at least one expander turbine or similar apparatus of corresponding functioning of type rotating machine, containing at least one partial step with or without an intermediate separation of feed water/condensate, wherein the expansion/condensation cooling of the expander turbines occurring during counter current fed condensate fractions from any of the ending turbine steps separation of feed water/condensate of lower pressure and temperature after which said fractions, in the whole or part of, are fed stepwise forward during increasing pressure and temperature as at discharge of preceding expander turbines of higher temperature, direct and/or indirect via heat exchangers, while the condensation effect of primary/secondary/residual heat/mass flow, comprising sensible and latent heat, is more effective and simultaneously the feed water/condensate is preheated before return to the first (I) stage of the conversion, which condensate in an open system representing said water supply during the oxidation/combustion/vaporization into the fuel and/or into the connection to the reaction/combustion chamber, after which the condensation cooling of the open system come to an end by separation of expansion cold condensate excess of the ending turbine step from when occurring condensation cooled inert gases, while the second (II) stage conversion of the systems producing power by at least one turbine connected generator, and/or another form of mechanical energy.

2. Method according to claim 1, wherein said energy sources including fuels as well as fuel similar substances and/or compounds comprising part or parts of: hydrogen, hydrogen compounds and hydrogen carbon compounds, as natural/bio gas, natural gas hydrate NGH and liquid natural gas LNG as well as any fuel gas from gasification, geothermal heat and/or any kind of by industrial process produced gases/liquids and/or reaction/conversion heat and/or combustion heat or another kind of heat as a whole or part of, furthermore comprising fuel/residual heat within nuclear power plants.

3. Method according to claim 1, wherein said hydrogen compounds including hydrogen peroxide H₂O₂, which compound as a whole or partially constituting besides a fuel also an oxidizing agent, simultaneously the reaction process can be pressurized by reaction of the hydrogen peroxide decomposition.

4. Method according to claim 1, wherein as oxidizing agent representing all kind of oxygen containing substances and/or compounds in liquid, gaseous or solid forms as a whole or part of.

5. Method according to claim 1, wherein the first (I) stage of the energy conversion including any kind of known reaction/oxidation/combustion processes, with or without at least one gas and/or steam turbine, with or without the expansion turbines of the second (II) stage energy conversion, for generation of power or production of another form of mechanical energy, said processes including reaction/combustion chamber with or without quench for separation of slag/melt with dissolver, pressurized fuel cell, condensing power plants and combined power and heating plants with or without fluidized bed or melt bed—or any kind of energy producers, which pressurized primary/secondary/residual heat/mass flow connects the steam turbines and/or said expansion turbines comprising steam cycle of nuclear power plants, and integrated gasification combined cycle (IGCC) in combination or parts of.

6. Method according to claim 1, wherein atomization medium of the reaction chamber burner system comprising hydrogen sulphide, hydrogen, gaseous compounds of hydrogen and/or hydrogen carbon, oxygen containing gas as a whole or parts of, preferably the medium moistened by water containing medium, preferred steam and/or hydrogen peroxide.

7. Method according to claim 1, wherein at least one of the steam/gas/condensate flows of the condensation cooling and/or at least one of the feed water/condensate flows of the condensation cooling, is/are utilized for preheating and/or vaporization and/or condensation via heat exchangers of at least one medium, preferably as at least one fuel and/or oxidizing agent and most preferred in the state of liquid/compressed/cooled and/or cooling medium cycle, when necessary additional condensation capacity is provided by another cooling medium.

8. Method according to claim 1, wherein the condensation cooling of the expander turbines comprising separation of at least one or part of condensate/feed water fractions when suitable for an exchange by supplying another water containing medium/feed water, of higher or corresponding temperature, preferably of lower temperature.

9. Method according to claim 1, wherein the method comprising a recovery/conversion of chemicals and/or organic substances from any kind of industrial gas—and/or liquid/residual/flows/liquors, for example black liquor of cellulose industry by one or more stages of reaction/oxidation progress in reaction/combustion chamber, by more stages preferably means sub stoichiometric combustion—gasification—followed by a stoichiometric/over stoichiometric combustion of by the first stage produced fuel gas, with or without another fuel supply, when suitable from said fuel gas recovering synthesis gas for further production of chemicals, mobile motor fuels etc. and/or mechanical energy.

10. Method according to claim 9, wherein the sub stoichiometric operating criteria of the first reaction/oxidation step preferably of high operating pressure, 20-220 bar (a), and high steam partial pressure during lowest possible operating temperature, preferably 820-970° C., for split of sodium (Na, K) and sulphur (S) compounds, when mainly said sodium compounds are separated mainly as a solid/liquid phase of slag/melt and sulphur compounds mainly as hydrogen sulphide comprising part of the fuel gas.

11. Method according to claim 9, wherein the recovery of synthesis gas comprising further processing into ammonia NH₃, hydrogen peroxide H₂O₂ and/or mobile motor/bio-fuels as dimethylether DME and/or methanol CH₃OH, or corresponding in the whole or part of.

12. Method according to claim 1, wherein the gas phase/mass flow content of suspended dust particles of coarse/fine/ultra fine sizes, which during the condensation cooling of the open system constitutes condensation nuclei for vaporized condensable substances and/or compounds besides water steam also unburned volatile hydrogen carbons and none process elements/heavy metals, whereby said dust particles are wetted and increased in weight and falling out of the said gas phase/mass flow and into the preheated liquid/condensate phase, which contaminated phase mainly is returned into the reaction chamber for destruction and vaporization.

13. Method according to claim 1, wherein out of the circulating liquid/condensate phase, and/or another condensate fraction, separating/recovering none process elements/heavy metals etc.

14. Method according to claim 1, wherein at an open system, both the first (I) and second (II) stages of the energy conversion comprising gas handling of by gasification produced fuel gas for recovering hydrogen sulphide and/or hydrogen and/or synthesis gas, and/or by combustion produced flue gas by oxygen as an oxidizing agent consisting of expansion cooled, more or less, carbon dioxide CO₂, which handling when suitable including return of at least one partial flow of said carbon dioxide into at least one reaction/combustion chamber and/or utilizing said carbon dioxide at another market and/or for final waste disposal of liquefied/compressed carbon dioxide deep into see or into suitable geological formation, comprising carbon dioxide as hauling agent for fuel/crude oil, and/or final waste disposal comprising adsorption into formations of black/brown coal/colliery for recovering hydrogen carbon compounds as for example methane.

15. Method according to claim 1, wherein the first (I) and second (II) stages of the energy conversion are followed by a third (III) stage representing some kind of by the second (II) stage heat exchangers integration of at least one cooling medium loop with for the process suitable cooling type of medium mainly fed counter current and including at least one pump and at least one of any kind of expander turbine producing mechanical energy, as for example power via at least one generator.

16. Method according to claim 1, wherein the first (I) and second (II) stages of the energy conversion with or without co-operation by a third (III) conversion stage constituting rotation motor for driving stationary apparatus/machines or mobile machine/means of transport/craft at land, sea or into air.

17. Method according to claim 16, wherein said mobile machine constituting hybrid vehicle driven by fuel fed arrangement/motor and/or electrically driven motor by generator and/or accumulator/battery.

18. Method according to claim 1, wherein the first (I), second (II) stages and when required a third (III) stage of the energy conversion are followed by an additional conversion stage consisting of any kind of power operated local heat pumps, when absent/restricted production of conventional secondary/residual heat/district heat for housing/local heating and production of tap off hot water is compensated/made up by said heat pumps, which energy sources includes part or parts of: waste heat, ground/rock, lake/sea/water, open air, mechanical ventilation/exhaust air, with or without heat supply by integration of any kind of solar heating systems, with or without heat pump integration of cooling plants.

19. Arrangement for recovering energy from any kind of energy sources and/or fuels, with fuel similar substances and/or compounds by at least one reaction/combustion chamber for thermal decomposition/combustion/gasification, by energy conversion in stages when said thermal decomposition/combustion/gasification including a first (I) stage of energy conversion, with or without at least one gas and/or steam turbine for production of mechanical energy, followed by extended conversion of a second (II) stage, which said second (II) stage arrangement representing expansion cooling by condensation of vaporized substances and/or compounds by at least one expander turbine or at least one expander turbine with at least two partial steps or similar apparatus of corresponding functioning of type rotating machine for production of mechanical energy, comprising when necessary at least one device for fractional separation of condensate/feed water, wherein the arrangement, in an open and/or a closed condensate/feed water system, mainly comprising counter current fed condensate/feed water with return of hot condensate/feed water in connection to any type of reaction/combustion device, or into another device with corresponding functioning, while at occurrence of condensate excess within the open system, separation occurring of cooled condensate excess preferably by an ending device while piping arrangement of the expander turbines comprising at least one heat exchanger constituting preheating/vaporization and/or cooling device/condenser for actual media, said heat exchangers furthermore when needed constituting part of arrangement for a third (III) conversion stage in form of at least one cooling medium loop, whereby the energy conversion mainly constituting production of mechanical energy in form of power by generators and/or device for driving a stationary machine or mobile machine/means of transport/vehicular/craft.

20. Arrangement according to claim 19, wherein this includes wholly or partially:
one or more energy sources comprising arrangement for utilizing geothermal heat and/or within industrial process produced reaction heat and/or any kind of heat or other sources as part or parts of: pressurized mass flow from at least one combustion/reaction chamber, pressurized fuel cell, steam cycle of combined power and heating plants or nuclear power plants as well as integrated gasification combined cycle IGCC,
at least one closed circulating steam/feed water system and/or at least one open partially circulating condense system with separation of expansion cooled condensate excess, comprising at least one stage of combustion device of almost atmospheric or pressurized within the closed system, while within the open system includes at least one stage of pressurized combustion device during increased steam partial pressure,
at least one condensation cooling arrangement comprising one or more expansion steps and/or partial steps, constituting separate units or one single multi step expander or another kind of rotating turbo machine, where every expander step or partial step or only when necessary are followed by at least one separation device for separation of feed water/condensate,
arrangement of at least one heat exchanger/condenser/pre heater/vaporizer into steam/gas/condensate piping and/or into feed water/condensate piping after expander turbines for preheating and/or vaporization of at least one fuel and/or at least one oxidizing agent or another suitable cooling medium, while counter current fed feed water/condensate is preheated before return to the energy conversion first (I) stage,
arrangement of heat exchangers when contaminated condensate and/or gas, a counter current fed gas phase vs. the condensate flow is preferred,
at least one air compressor for feeding pressurized oxidizing agent, preferably without inter stage cooling and with or without water injection cooling, and/or device for supply of other oxygen containing substances or compounds, wholly or partially,
at least one low temperature loop of circulating counter current fed cooling medium in co-operation with said heat exchangers, comprising at least one pump and at least one expander turbine, or similar apparatus of corresponding functioning of type rotating machine, for condensation cooling and production of mechanical energy, for example generation of power by at least one generator,
arrangement within the open system for condensation and elimination of gas containing dust particles of coarse/fine/ultra fine sizes as well as un-burnt hydrogen carbons, which are transferred into the liquid phase for injection and destruction in connection to the energy conversion first (I) stage,
device within the circulating condensate of the open system, and/or another condensate fraction, for separation/recovery of non process elements/heavy metals,
generation of power by at least one expander turbine driven generator of the second (II) stage of energy conversion as well as when appropriate also by at least one preceding gas and/or steam turbine driven generator of the first (I) stage of conversion,
arrangement for separation of at least one or part of the condensate/feed water fractions of the expansion cooling, when suitable for an exchange by supplying another water containing medium/feed water of higher or corresponding temperature, preferably of lower temperature,
at least one arrangement for recovering chemicals/melt/salts and/or device for recovering sulphur dioxide from flue gas, as well as from fuel gas: hydrogen and/or synthesis gas for production of bio-/vehicle-fuels and/or hydrogen peroxide or other compounds,
at least one static and/or dynamic short time contactor device for selective absorption of hydrogen sulphide and/or sulphur dioxide, preferably by alkaline medium and series in counter current,
at least one arrangement for taking care of expansion cooled flue gas, of almost only carbon dioxide, as a partial flow when suitable to be returned into at least one reaction/combustion chamber and/or to be utilized at another market and/or as final waste disposal deep into sea or into suitable geological formations, comprising carbon dioxide as hauling agent for fuel and/or for adsorption into formation of black/brown coal/colliery for recovering hydrogen carbon compounds as methane,
vacuum strengthened device at the ending expander step comprising liquid ring pump or corresponding apparatus and/or fan and/or barometric fall leg with water seal—for require controlled vacuum,
construction material of expansion turbine/turbo machine, or similar apparatus of corresponding function, by corrosion and erosion resistant quality at exposed parts of apparatus,
heat pump arrangement for require controlled local heat production for housing/local heating and production of tap off hot water.

21. Arrangement according to claim 19, wherein the first (I) and second (II) stages of the energy conversion with or without the third (III) stage are utilized for driving stationary or mobile apparatus/machine—the later any kind of vehicle/means of transport/craft at land, sea or into air, also comprising wholly or partially:
at least one pressurized combustion/vaporization/reaction chamber with or without integration of at least one pressurized fuel cell with at least one expansion turbine with or without preceding at least one steam turbine step by the first (I) and second (II) stages of energy conversion, with or without the third (III) stage of the cooling medium loop, co-operated driven by electricity, by mechanical and/or hydraulic power transmission or in another way,
combustion/vaporization/reaction chamber with compressor and gas turbine and/or steam turbine representing the first (I) conversion stage,
device for the supply/vaporization of cooled/compressed liquid media as oxidizing agents and/or fuels, comprising hydrogen and methane,
generator with reversible drive as a starting function, alternatively by separate starter motor,
at least one accumulator/battery with at least one electrical motor for electrically driven possibility of hybrid vehicle.
possibility for individual motor drive of wheels/propellers or corresponding.
